(19) United States
(12) Patent Application Publication
(10) Pub. No.: US 2014/0309772 A1
(43) Pub. Date: Oct. 16, 2014

(54) SYSTEM AND METHOD FOR DISPENSING PILL

(71) Applicant: HON HAI PRECISION INDUSTRY CO., LTD., New Taipei (TW)

(72) Inventors: PAO-HENG SHEN, New Taipei (TW); KUO-MING LAI, New Taipei (TW)

(73) Assignee: HON HAI PRECISION INDUSTRY CO., LTD., New Taipei (TW)

(21) Appl. No.: 14/226,433

(22) Filed: Mar. 26, 2014

(30) Foreign Application Priority Data
Apr. 12, 2013 (TW) 102112996

(51) Int. Cl. G06F 19/00; A61J 7/04

(52) U.S. Cl. CPC G06F 19/3462; A61J 7/0481
USPC 700/237

(57) ABSTRACT

A system for dispensing pills includes an automatic pill dispenser and a data center. The automatic pill dispenser can store different kinds of pills. The data center is connected to the automatic pill dispenser. The data center includes a cloud server, which stores patient's information. The patient's information includes patient's identification information and pill schedule. The automatic pill dispenser gets the pill schedule based on validated identification information, and can select different kinds of pills according to the pill schedule.

### FIELD

The disclosure generally relates to pill dispensing systems and methods, especially to an automatic pill dispensing system and method.

### BACKGROUND

It is common for the elderly or infirm to ingest many different pills according to a schedule. The scheduling can be complex and involve taking medication in different amounts at different times. Such complexities can be difficult to remember and can result in dangerous mistakes.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a diagrammatic view of an embodiment of a system for dispensing pill.

FIG. 2 is a diagrammatic view of an automatic pill dispenser of the system of FIG. 1.

FIG. 3 is a flow chart of an embodiment of a method for dispensing pill.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

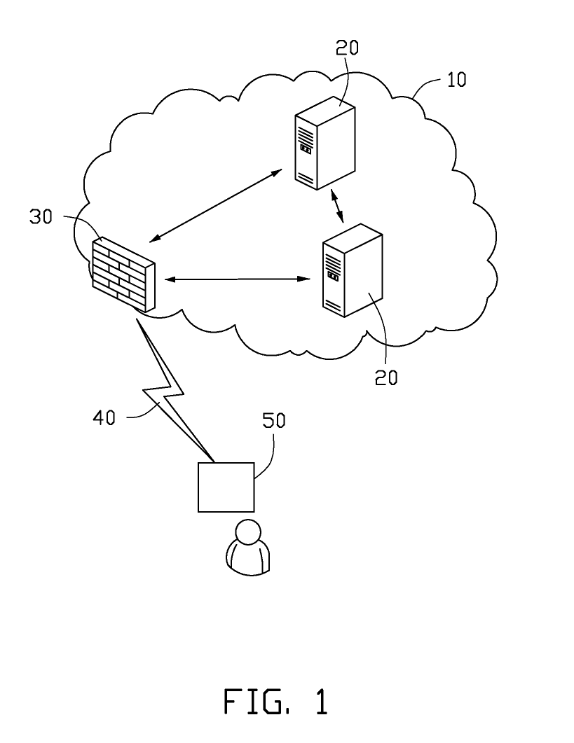

FIG. 1 shows one embodiment of a pill dispensing system. The pill dispensing system can include a data center 10. An automatic pill dispenser 50 can be connected to the data center 10 via a network 40. Different kinds of pills can be stored in the automatic pill dispenser 50.

The data center 10 can include one or more cloud servers 20 and a fire wall 30. The fire wall 30 can be used to protect the cloud servers 20 from being infiltrated or accessed by unauthorized users.

The network 40 can be internet network, an local area network, another communication network, or a combination thereof.

The cloud server 20 can assign an internet protocol address for the automatic pill dispenser 50, access the automatic pill dispenser 50, and authorize the automatic pill dispenser 50 to access the cloud server 20.

The cloud server 20 can store a patient's information, such as the patient's name, age, height, weight, visual acuity, disease status, media case history, pill schedule, and identification information, for example.

The automatic pill dispenser 50 can access the cloud server 20 and retrieve the patient's information from the cloud server 20.

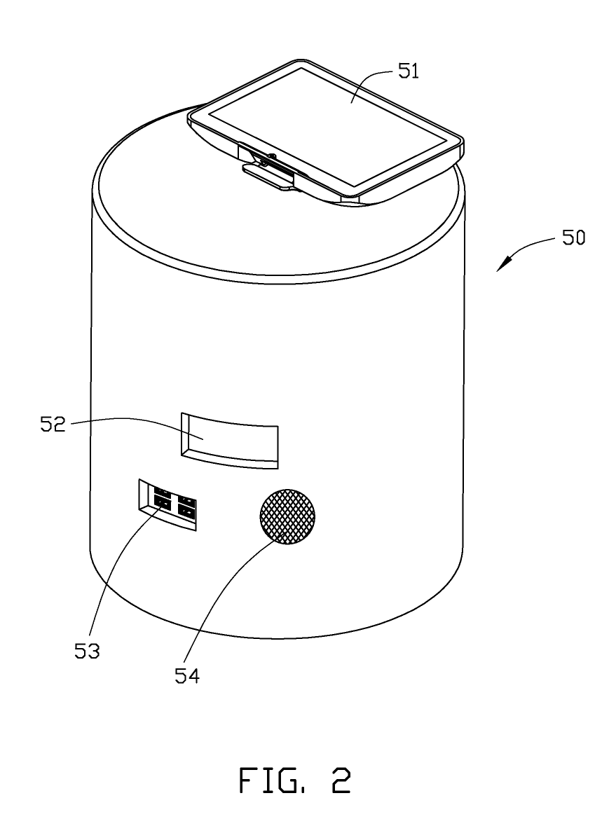

FIG. 2 shows one embodiment of the automatic pill dispenser 50. The automatic pill dispenser 50 can include a screen 51, a pill dispensing opening 52, an information input apparatus 53, and a speaker 54. In one embodiment, the screen 51 is a touch screen which can be used for inputting information. The screen 51 can be pivotally mounted on the automatic pill dispenser 50.

The information input apparatus 53 can be used to input the patient's identification information. In one embodiment, the information input apparatus 53 is an USB receiver. The patient's identification information can be stored in a USB apparatus. The USB apparatus can be inserted in the information input apparatus 53 to input the patient's identification information into the automatic pill dispenser 50. The automatic pill dispenser 50 then transmits the patient's identification information to the cloud server 20. In another embodiment, the patient's identification information can be stored in a mag-card, and the input apparatus 53 can be a mag-card receiver to receive the mag-card.

The cloud server of the data center can find the patient's pill schedule according to the patient's identification information, and controls the automatic pill dispenser 50 to select corresponding pills according to the patient's pill schedule. The selected pills can be dispensed from the pill dispensing opening 52. The cloud server 20 also can control a height and an angle of the screen 51 according to the patient's height and visual acuity. Further, a font size shown on the screen 51 can be adjusted based on the patient's visual acuity. For the patient whose visual acuity is very low, the speaker 54 can be controlled to broadcast the patient's information. Further, the speaker 54 can broadcast some music to please the patient.

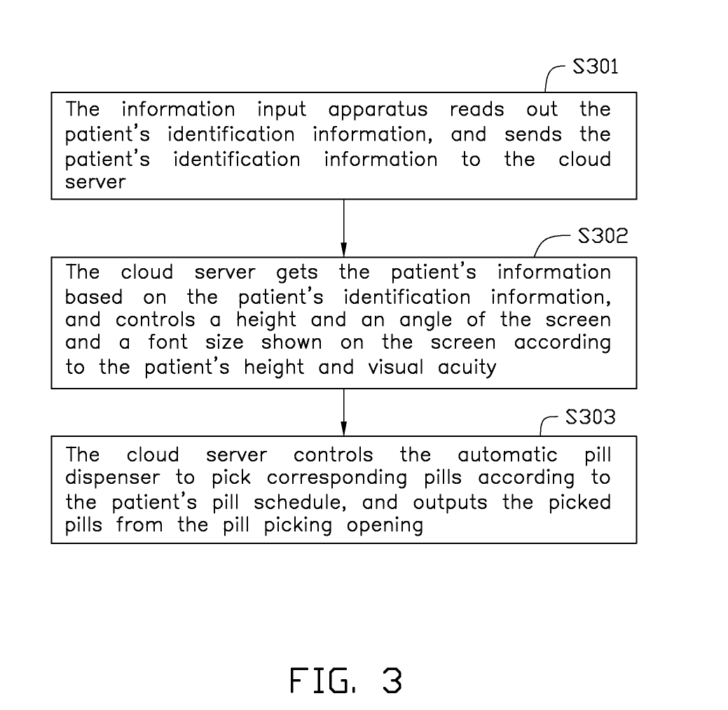

FIG. 3 shows a method for dispensing pill.

In S301, the information input apparatus reads out the patient's identification information, and sends the patient's identification information to the cloud server.

In S302, the cloud server gets the patient's information based on the patient's identification information, the cloud server controls a height and an angle of the screen 51 and a font size shown on the screen according to the patient's height and visual acuity. For the patient whose visual acuity is very low, the speaker can be controlled to broadcast the patient's information.

In S303, the cloud server controls the automatic pill dispenser to select corresponding pills according to the patient's pill schedule, and outputs the selected pills from the pill dispensing opening.

In another embodiment, all of the patient's information can be stored in the USB apparatus. Therefore, the automatic pill dispenser can read out the patient's information directly from the USB apparatus to dispense pills for the patient.

In another embodiment, a camera can be mounted on the automatic pill dispenser. The camera can recode the patient's action on the automatic pill dispenser.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An automatic pill dispenser, comprising:
an information input apparatus for inputting patient's information which comprises patient's height and pill schedule; and
a movable screen, wherein a height of the screen is configured to be adjusted based on the patient's height, and a different kind of pill can be selected based on the pill schedule.

2. The automatic pill dispenser of claim 1, wherein the information input apparatus is a USB receiver or a mag-card receiver.

3. The automatic pill dispenser of claim 1, wherein the patient's information further comprises the patient's visual acuity, and a font size shown on the screen is configured to be adjusted based on the patient's visual acuity.

4. The automatic pill dispenser of claim 1, further comprising a camera, wherein the camera is configured to recode the patient's action.

5. The automatic pill dispenser of claim 1, further comprising a speaker, wherein the speaker is configured to broadcast the patient's information.

6. The automatic pill dispenser of claim 1, further comprising a pill dispensing opening, configured to dispense a selected pill or pills.

7. A system for dispensing pills, comprising:
an automatic pill dispenser; and
a data center connected to the automatic pill dispenser, the data center comprising a cloud server which stores patient's information therein, the patient's information comprising patient's identification information and pill schedule;
wherein the automatic pill dispenser is configured to get the pill schedule based on validate the identification information, and select a different kind of pill according to the pill schedule.

8. The system of claim 7, wherein a screen is movably mounted on the automatic pill dispenser, the patient's information comprises the patient's height, and a height of the screen is configured to be adjusted based on the patient's height.

9. The system of claim 7, wherein the patient's information further comprises visual acuity, and a font size shown on the screen is configured to be adjusted based on the patient's visual acuity.

10. The system of claim 7, wherein the automatic pill dispenser further comprises an information input apparatus, and the information input apparatus is configured to read the patient's identification information.

11. A method for dispensing pills, comprising:
storing patient's information in a cloud server, wherein the patient's information comprises patient's identification information and pill schedule;
validating the patient's identification information; and
selecting pills from an automatic pill dispenser based on the pill schedule when the patient's identification information is validated correctly.

12. The method of claim 11, wherein a screen is movably mounted on the automatic pill dispenser, the patient's information further comprises the patient's height, and a height of the screen is configured to be adjusted based on the patient's height.

13. The method of claim 12, wherein the patient's information comprises visual acuity, and a font size shown on the screen is configured to be adjusted based on the patient's visual acuity.

14. The method of claim 11, wherein the automatic pill dispenser comprises a speaker, wherein the speaker is configured to broadcast the patient's information.
